(19) United States
(12) Patent Application Publication
(10) Pub. No.: US 2012/0328753 A1
(43) Pub. Date: Dec. 27, 2012

(54) NON ROTATING RACK OVEN

(76) Inventor: Ron Mondello, Jericho, NY (US)

(21) Appl. No.: 13/116,456

(22) Filed: May 26, 2011

Related U.S. Application Data
(60) Provisional application No. 61/349,476, filed on May 28, 2010.

(51) Int. Cl. A47J 37/00; A23L 1/01

(52) U.S. Cl. 426/523; 99/474; 126/21 A

(57) ABSTRACT

A cooking apparatus (10) that comprises a cooking chamber (14) with an access door (16); a heating system (20) that radiates heat into the cooking chamber (14); and a plurality of air flow fans (32a, 32b, 32c, 32d) circulating air within the cooking chamber (14) to distribute the heat in a substantially even manner within the cooking chamber (14).

### CROSS-REFERENCE TO RELATED APPLICATIONS

This application claims the benefit of Provisional U.S. Patent Application Ser. No. 61/349,476, entitled, “A Non Rotating Rack Oven”, filed in the name of Ron Mondello on May 28, 2010, the disclosure of which is also hereby incorporated herein by reference.

### FIELD OF INVENTION

The present invention relates to food preparation and cooking apparatus. More particularly, the present invention relates to forced air convection rack ovens.

### BACKGROUND OF THE INVENTION

Commercial food establishments, such as bakeries, restaurants, supermarket kitchens, etc., typically use a number of different specialty food preparation and cooking equipment in order to operate efficiently. Even within a certain category of equipment, there are various types depending upon the specific application and the implementing technology. Ovens, for example, are available in different types, although the industry-accepted names sometimes do not readily reveal the distinguishing operating characteristics. Deck ovens are constructed with one or more horizontal surfaces or decks, which hold the foodstuff to be heated, within an oven's cooking chamber. There are several designs of deck ovens that are distinguished in how the heat is distributed to the decks (and thereby applied to the foodstuff). Deck ovens are often used for roasting and baking applications. Convection ovens use heating elements to generate heated air and a fan or blower to circulate the heated air throughout the cooking chamber and past the food. The air circulation or convection distributes the heated air to equalize the temperature within the chamber and to cook the food more evenly than radiated heat. Convection ovens are versatile and may be used in many applications, including roasting, baking, and warming.

One of the most widely-used type of commercial oven is the rack oven. The rack oven is a form of convention oven that has a cooking chamber designed to accommodate a food rack, which is a food handling apparatus that has multiple horizontal shelves, each of which can support a container or pan that holds foodstuff to be heated. In larger-sized rack ovens, a food rack is usually rolled into the floor-level cooking chamber. Typically, a rack oven has a chamber mechanism which secures and, in some designs, rotates the food rack during the convective heating operation. Rack ovens are commonly used for baking, steaming, and thawing applications.

A typical rack oven is designed with heating elements that generate heat in a compartment separate from the cooking chamber. Most rack ovens are further designed with a fan in the ceiling, or the back wall, of the cooking chamber that forces the heated air from the bottom to the top of the cooking chamber (creating a “bottom-to-top” forced hot air circulation path). A rack oven also has a number of adjustable air louvers in the walls of the cooking chamber that are used to assist the fan in equalizing the temperature throughout the cooking chamber and that need to be constantly adjusted during operation of the rack oven. High velocity fans are required for typical rack ovens in order to force the heated air throughout the cooking chamber and around the racks and foodstuffs and through all the air louvers in the chamber. Experience has shown, however, that the bottom-to-top forced hot air and the high velocity heated air tends to dry out baking products, especially those located at the peripheries of the pans which are the most exposed to the heated air. Further, the air louvers are often not sufficient to assist the bottom-to-top forced hot air in consistently achieving uniform heating, baking, or cooking of the foodstuffs, which receive different heating depending upon the location on a respective pan and the location of the respective shelf on the rack. It is common practice to open the cooking chamber during operation and to manually move and shift the pans, or move the foodstuff, to try to insure the foodstuff is evenly heated, baked or cooked.

### SUMMARY OF THE INVENTION

The above problems are obviated by the present invention which provides a cooking apparatus, comprising an enclosure having interior compartments that are adapted to contain components of the apparatus and at least one of which is adapted to contain foodstuff to be heated or cooked; a heating system located in at least one of the compartments which heats the air used in the cooking compartment to heat or cook foodstuff contained therein; and an air flow circulation system located in at least one of the compartments which circulates the heated air throughout the cooking compartment and around and about the foodstuff, the circulation system providing distributed air flow circulation paths that force heated air from one side of the cooking compartment to the other side and back. The heating system may comprise a heating source that generates the heat used to heat the air in the cooking compartment and a heat exchanger that transfers the generated heat from the heat source to the air circulated by the air flow circulation system.

Further, the air flow circulation system may comprise a plurality of fans arranged in a column along the back or a side wall of the cooking compartment, each of which circulates the heated air within respective top, middle, and bottom volumes of the cooking compartment roughly corresponding to a fan's position in the column arrangement. In such case, each fan circulates the heated air within a respective volume of the cooking compartment that has a main plane generally defined from the vertical location of the fan in the column to the corresponding vertical positions on the other walls, each volume extending vertically above and below the main plane. Also, the plurality of fans may be located in the air flow circulation compartment and extend into the cooking compartment at the back or a side wall of the cooking compartment. Also, the air flow circulation system may further comprise a plurality of air ports formed in a back or a side wall of the cooking compartment that function as air returns for the circulated heated air in the cooking compartment. The plurality of air ports may be divided in portions that are equal in number to the number of fans and that establish a one-to-one correspondence with the fans. Further, the plurality of fans may be located in the air flow circulation compartment, each of which is aligned with a respective air port that permits the fan to circulate air within the cooking compartment and that acts as an air return for the circulated heated air.

The present invention also provides an oven, comprising a cooking chamber that is adapted to accommodate a food rack holding foodstuff to be cooked or heated; a plurality of fans arranged along the back or a side wall of the cooking chamber; and a plurality of air returns formed in the back or a side wall of the cooking chamber, the fans and the air returns working in combination to form distributed air flow circulation paths that force heated air from one side of the cooking chamber to the other side and back circulating heated air throughout the cooking chamber and around and about the foodstuff held by the food rack. The plurality of air returns may be divided in portions that are equal in number to the number of fans and that establish a one-to-one correspondence with the fans. Also, the distributed air flow circulation paths may be formed within top, middle, and bottom volumes of the cooking chamber roughly corresponding to a fan's vertical position along the back or a side wall. Alternatively, each distributed air flow circulation path may be formed within a respective volume of the cooking chamber that has a main plane generally defined from the vertical location of the fan to the corresponding vertical positions on the other walls, each volume extending vertically above and below the main plane and overlapping adjacent volumes. The distributed air flow circulation paths may circulate heated air side to side across the cooking chamber and across a food rack contained therein to equalize the air temperature across the food rack and the foodstuff held by the food rack. Alternatively, the distributed air flow circulation paths may circulate heated air side to side across the cooking chamber and across the top and bottom of each foodstuff pan held by a food rack contained therein to maintain a respective even air temperature across the top and the bottom of each foodstuff pan.

The present invention may also provide a method of cooking, comprising providing a cooking chamber that is adapted to accommodate a food rack having at least one tray holding foodstuff to be cooked or heated; generating heated air in the cooking chamber to cook or heat the foodstuff; and circulating the heated air throughout the cooking chamber using a plurality of primary air flow circulation paths that force heated air from one side of the cooking chamber to the other side and back and across the top and bottom of each foodstuff tray of a food rack contained therein to maintain a respective even air temperature across the top and the bottom of each foodstuff pan. The circulating step may comprise initially circulating the heated air in a respective primary air flow circulation path at an operating rate of 275 feet per minute. The method may further comprise returning circulated heated air from each primary air flow circulation path to be re-heated using the generating step and re-circulated using the circulating step. In such case, the returning step may comprise returning circulated heated air from each primary air flow circulation path primarily using a respectively defined air return path for each primary air flow circulation path.

### DESCRIPTION OF THE DRAWINGS

For a better understanding of the present invention, reference is made to the following description of an exemplary embodiment thereof, and to the accompanying drawings, wherein:

FIG. 1 is a schematic representation of a cooking apparatus constructed in accordance with the present invention;

FIG. 2 is a schematic representation of the interior of the cooking apparatus of FIG. 1; and

FIG. 3 is a schematic representation of a cooking chamber of the cooking apparatus of FIG. 1.

### DETAILED DESCRIPTION

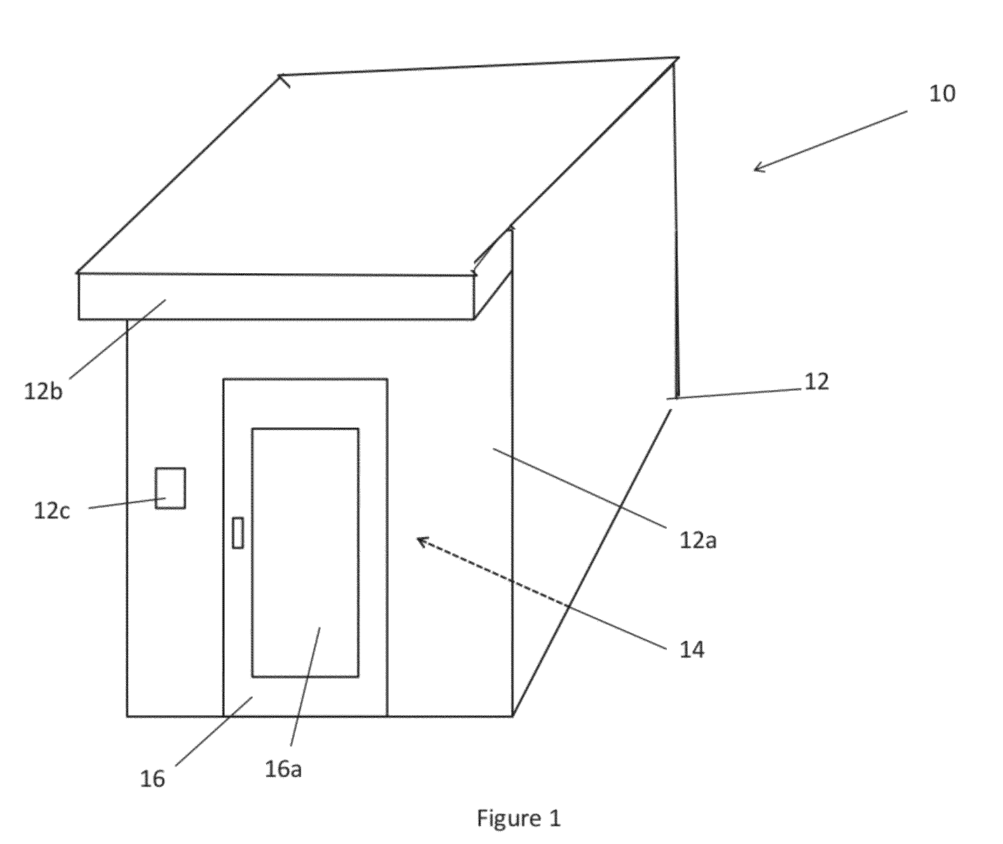

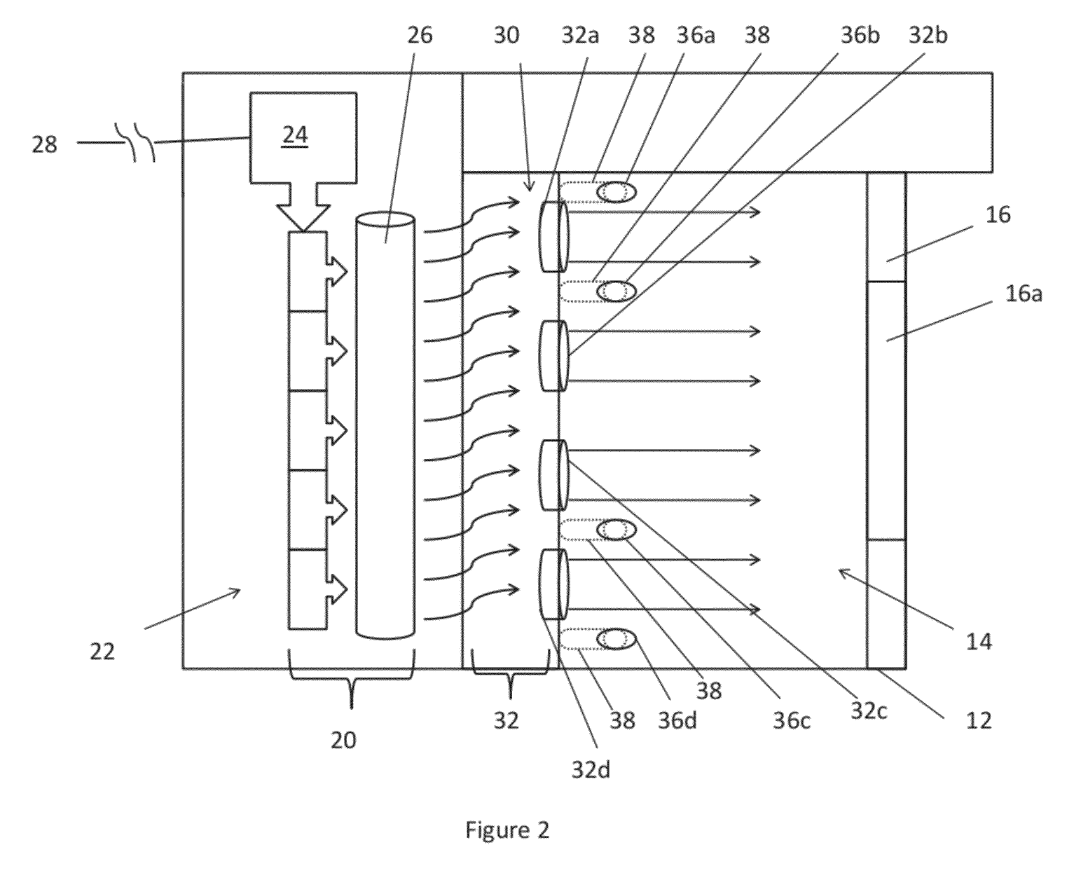

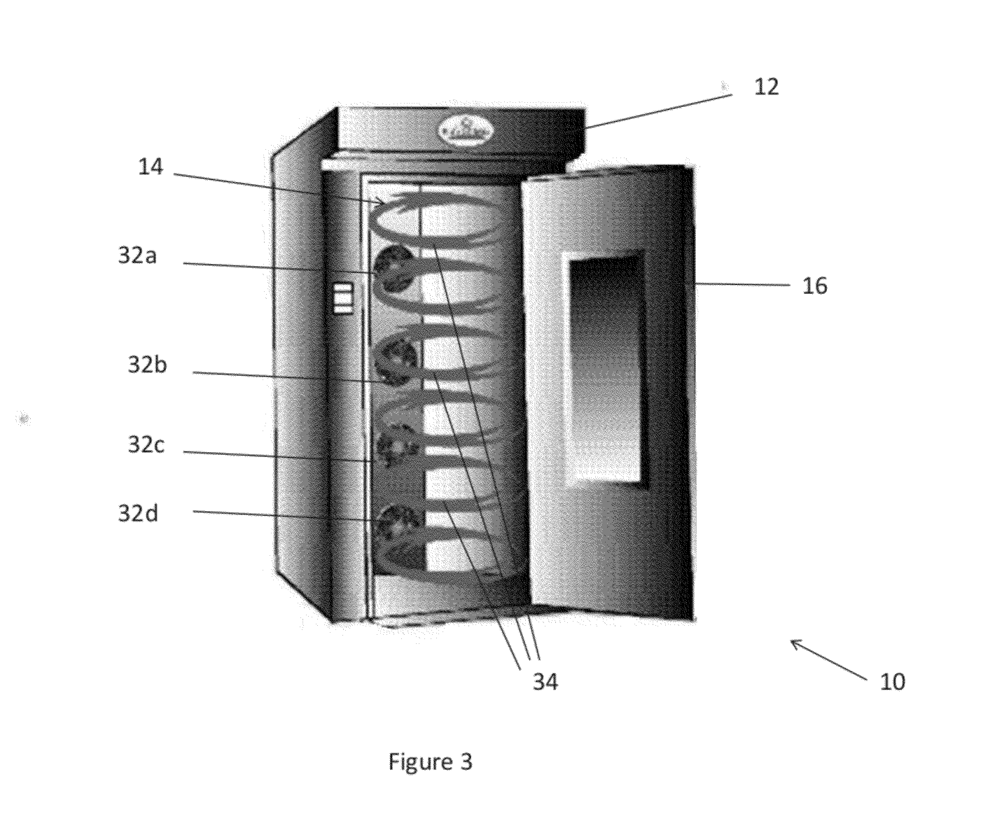

FIG. 1 is a schematic representation of a cooking apparatus 10 constructed in accordance with the present invention. The cooking apparatus 10 comprises a housing or an enclosure 12 having a main body 12a formed to be rectangular and having its long axis in the vertical direction as its height dimension. The enclosure 12 and the main body 12a, however, may each be of any size and shape depending upon the application and the apparatus components to be housed therein and is otherwise a matter of design preference. The main body 12a of the enclosure 12 defines a closed interior space or cavity 14 therein that is generally smaller but similarly sized and shaped as the main body 12a (although this is also a matter of design preference). The closed interior cavity 14 (also shown in FIGS. 2 and 3) is adapted to operate as a cooking chamber for the cooking apparatus 10 as detailed below. The enclosure 12 may also be configured to have at least one separate compartment or secondary body 12b which may contain certain components, i.e., the operating electronics and mechanisms, for the cooking apparatus 10. Typical larger-sized components may include a hood ventilation exhaust, steam generation system, heating system, and food rack lift system. Further, the enclosure 12 may be configured to have ample room within the exterior and interior walls of the enclosure 12 to contain some of the operating electronics and mechanisms. Some of the controls of the cooking apparatus 10 may be accessible to an operator via a standard control pad 12c with associated electronics located on an exterior wall of the enclosure 12. The enclosure 12 may be made of suitable or customary materials to permit the proper operation of the cooking apparatus 10. For example, the enclosure 12 may primarily be made of stainless steel construction in both the exterior and interior areas. The enclosure 12 walls may further include any suitable high-temperature insulation, especially around the cooking chamber 14.

The enclosure 12 comprises a hinged access door 16 that is formed on one wall of the enclosure 12 and that opens the cooking chamber 14. The access door 16 is adapted to provide a tight seal when closed and during operation of the cooking apparatus 10. The access door 16 may be further adapted to accommodate an appropriate gasket to assist in providing a tight seal. The access door 16 may be formed with a viewing window 16a made of transparent material to permit viewing of the cooking chamber 14 when the access door 16 is closed. The transparent material may be any material suitable or customarily used to permit viewing and that can withstand the operation and temperatures of the cooking chamber 14, such as double glass.

As noted above, the cooking chamber 14 is generally smaller than the main body 12a of the enclosure 12. For larger commercial applications, the cooking chamber 14 may comfortably accommodate a conventional food rack to permit the free flow of heated air about the foodstuff to be heated. Again, as noted above, a food rack is a food handling apparatus having a frame that has multiple horizontal narrow shelves, each of which can support a container or pan that holds foodstuff to be heated. The bottom of the frame usually has casters or other means to permit the food rack to be easily moved from place to place. Alternatively, the cooking chamber 14 may be adapted to function as a food rack. For example, the cooking chamber 14 may comprise at least one shelf that may be attacheable to at least one wall of the cooking chamber 14. The shelf may be configured as an L-shaped structure or bracket or otherwise configured to hold a food container/pan. Also, at least one wall of the cooking chamber 14 may be configured with integrally-formed projections or supports to adaptively hold a container/pan. Further, the integrally-formed projections or supports may adaptively hold a container/pan via the side edges of the container/pan and permit the container/pan to be slidably moved in and out of the cooking chamber 14 through the access door 16.

FIG. 2 is a schematic representation of the interior of the cooking apparatus 10. As shown in the figure, the cooking apparatus 10 also comprises a heating system 20 that heats the air that will be circulated within the cooking chamber 14. The heating system 20 may be located in at least one heating compartment 22 separate from the cooking chamber 14. The heating system 20 comprises a heat source 24 and a heat exchanger 26, although the system 20 may take on other configurations and comprise more, less, or different components. The heat source 24 may be a fuel burner, such as a gas burner (e.g., natural gas, liquid propane) or an electrically-energized radiant heating element. The heat source 24 and the cooking apparatus 10 are appropriately connected to an energy supply 28 for the heat source 24, e.g., natural gas line, LP tank, electrical power outlet. Further, the heat source 24 may take on various forms and comprise various components such as in-shot burners, thermostat controls, gas manifolds, temperature and flame sensors, burner blowers, combustion gas exhausts, etc.

The heat exchanger 26 transfers the heat generated from the products of combustion of the fuel burner or the radiated heat of the electrical radiant element to a separate fan compartment 30. The heat exchanger 26 may take on any suitable and customary form, such as a tube or spiral arrangement or an air channel arrangement. Further, the heat exchanger 26 may be made of suitable or customary materials (e.g., stainless steel or other high temperature resistant material) and constructed in various ways (e.g., unitary, welded, interlocking) to affect efficient heat transfer and uniform heat distribution. It is noted that the cooking chamber 14 is constructed to generally seal the cooking chamber 14 from the remainder of the cooking apparatus 10 and, in particular, the heating and fan compartments 22, 30. This permits the cooking chamber 14 to operate more efficiently. Also, in the case of a fuel burner for a heating source 24, this helps to block the combustion products from entering the chamber 14.

The cooking apparatus 10 further comprises an air flow circulation system 32 having a plurality of air flow fans or blowers 32a, 32b, 32c, 32d (four shown for illustration purposes) that are located in the fan compartment 30 and extend into the cooking chamber 14 at the back wall (i.e., the wall opposite the access door 16). Alternatively, the air flow fans 32a, 32b, 32c, 32d may extend into the cooking chamber 14 at a sidewall. The air flow fans 32a, 32b, 32c, 32d may expel and circulate (into the cooking chamber 14) heated air transferred into the fan compartment 30 by the heat exchanger 26 and/or may circulate the air in the cooking chamber 14 for heating, depending upon the configuration of the apparatus 10.

A plurality of air ports 36a, 36b, 36c, 36d may also be formed in the side or back wall and function as air returns for the circulated heated air. The air ports 36a, 36b, 36c, 36d form openings to the fan compartment 30 (or directly to the air intakes of the air flow fans) if at the back wall or to air passages 38 within the side walls that go to the fan compartment 30 (or that go directly to the air intakes of the air flow fans) if at the side walls. Four are shown for illustration purposes but the air ports may take on other numbers (other than equal to the number of fans) and other configurations. For example, each of the side walls of the chamber 14 may have a dispersed arrangement of a plurality of air ports 36. Also, the air ports 36 may be configured to be co-located with the fans 32 (e.g., in a nested arrangement). Each of the air ports 36 may or may not be shaped and sized as each of the other ports. As described in detail below, the air ports 36 and the air passage (or passages) 38 that are positioned around the horizontal plane of a respective air flow fan 32 (and, if used, the fan compartment 30) form the primary air return for the respective fan 32 The apparatus 10 may be configured to so that these horizontally-aligned air ports 36 and air passage 38 are operably and/or structurally connected only to the respective fan 32.

Further, the air flow fans 32a, 32b, 32c, 32d may not physically extend into the cooking chamber 14 but may only align with respective air ports 36a, 36b, 36c, 36d formed in a chamber 14 wall, that permit the fans 32a, 32b, 32c, 32d to expel and circulate heated air in the fan compartment 30 into the chamber 14 (and/or circulate heated air within the chamber 14) and that also act as air returns for the circulated heated air. The fan compartment 30 may enclose a single space or may be partitioned into sub-compartments. Each sub-compartment may be operably and/or structurally connected with a respective air flow fan 32a, 32b, 32c, 32d and with the respective horizontally-aligned air passage (or passages) 38 and air port (or air ports) 36 for the fan 32 to facilitate the forming of specific air flow circulation paths and specific air return paths for each air flow fan 32.

As shown in FIG. 3, the fans 32a, 32b, 32c, 32d are arranged in a column on the back wall, with generally even spacing between each one, the ceiling, and the floor of the cooking chamber 14. The fans 32a, 32b, 32c, 32d expel and circulate the heated air in the fan compartment 30 into the cooking chamber 14 and/or circulate heated air within the chamber 14. More specifically, each fan 32a, 32b, 32c, 32d circulates heated air within the respective top, two middle, and bottom volumes of the chamber 14 roughly corresponding to fan's position in the column arrangement. The plurality of fans generates multiple, primary air flow circulation paths 34 (i.e., distributed air flow circulation paths) rather than one primary circulation path that results from using a single fan in typical rack ovens. Moreover, the distributed air flow circulation paths 34 extend from one side of the cooking chamber 14 to the other side and back (i.e., “side-to-side” forced hot air circulation path). The fans 32a, 32b, 32c, 32d may be configured in combination with the heat exchanger 26 to take heat from the heat exchanger 26 more directly, e.g., have the heated air from the heat exchanger 26 pass in front of the fans or pass directly into air intakes for the fans. The fans 32a, 32b, 32c, 32d may be any suitable type, for example, a squirrel cage blower, according to design preference. Also, the fan velocity of each fan 32a, 32b, 32c, 32d may be individually adjusted via the control pad 12c as desired.

In operation, the heat source 24 is activated by appropriate controls, mainly via the control pad 12c, for the cooking apparatus 10. The controls permit an operator to set various operating parameters, such as the cooking chamber 14 temperature, operation times, fan velocities, etc. The heat source 24 heats outside air that is drawn into the heating compartment 22 by conventional means. More specifically, the heat source 24 heats the drawn-in air at the intake portions of the heat exchanger 26. In some configurations, the heat source 24 may directly heat the intake portions of the heat exchanger 26 which also takes in the drawn-in air (e.g., by being directly coupled to an intake of the heat exchanger 26). The heat exchanger 26 transfers the heat generated from the heat source 24 to the fan compartment 30 or sub-compartments. The particular operation of the heat exchanger 26 depends upon the configuration of the heat source 24 with the heat exchanger 26. In a common configuration, the heat source 24 is a gas-fired burner that has its combustion gas and flame ported through an appropriate manifold to several intakes of the heat exchanger 26. The heat exchanger 26 distributes the combustion heat along its form, such as a tubular arrangement, and transfers the heat along its form to the fan compartment 30.

As noted above, the configuration of the heat exchanger 26 with the air flow fans 32a, 32b, 32c, 32d can take on various forms. In a common configuration, the heat exchanger 26 transfers heat directly into air intakes for the fans 32a, 32b, 32c, 32d. Regardless, the fans expel and circulate heated air into the cooking chamber 14 (and/or circulate heated air within the chamber 14). The operator sets the fan velocities at generally low velocities via the apparatus 10 controls. Each fan 32a, 32b, 32c, 32d specifically circulates the heated air in an air flow pattern or patterns 34 in the respective volume of the cooking chamber 14 that has a main horizontal plane generally defined from the vertical location of the fan in the column along the back wall to the corresponding vertical positions on the front and side walls. The remainder of a volume extends vertically above and below the main plane and a volume may overlap other air circulation volumes. The sizing, velocity, placement, and quantity of the fans all contribute to defining the dimensions of each air circulation volume and the air flow patterns. As noted above, the distributed air flow circulation paths 34 extend from one side of the cooking chamber 14 to the other side and back (i.e., “side-to-side” forced hot air circulation path). The paths 34 also return circulated heated air back into the fan compartment 30, or sub-compartment, or directly to the air intakes of the air flow fans 32a, 32b, 32c, 32d via the air ports 36a, 36b, 36c, 36d and the air passages 38 to be re-heated and then re-circulated. Each path 34 formed by a respective air flow fan 32 returns circulates heated air to the fan 32 primarily via the air ports 36 and the air passage 38 (and, if used, the fan compartment 30 or sub-compartment) in the respective volume for the path 34. As noted above, the apparatus 10 may be configured to so that the air ports 36 and the air passage 38 (and, if used, the fan compartment 30 or sub-compartment) in a respective volume for a path 34 are operably and/or structurally connected only to the respective air flow fan forming the path 34. Defining specific air return paths aids the operation of the air return and air flow circulation paths for each air flow fan 32.

The air flow patterns 34 follow generally circular or oval paths but may be differently formed. In all cases, however, the fans 32a, 32b, 32c, 32d produce distributed air flow circulation paths 34 that circulate the heated air from one side to the other side of the cooking chamber 14 and back, passing over and about the foodstuff held by the multiple levels of a food rack. Circulating the heated air side to side across the cooking chamber 14 moves the heated air across a food rack (i.e., horizontally rather than vertically like a typical rack oven) to equalize the air temperature across the food rack and the foodstuff held by the food rack. Further, the side-to-side circulated air moves across both the top and bottom of each foodstuff pan held by a food rack to maintain a respective even air temperature across both the top and the bottom of each foodstuff pan. In this way, the fans 32a, 32b, 32c, 34d control more effectively the air distribution as well as the temperature distribution in the chamber 14. For most applications, the cooking chamber 14 may operate in a temperature range between 250° F. and 500° F. and with rated fan velocities of 125 cubic feet per minute for each air flow fan 32. In contrast, typical rack ovens have higher operating fan velocities (between 700 and 1500 cubic feet per minute).

The side-to-side forced hot air circulation paths 34 provided by the cooking apparatus 10 has several advantages that result in higher quality heated, baked or cooked foodstuff. For example, the air flow fans 32a, 32b, 32c, 32d move heated air over the foodstuff more directly and evenly than a single fan of standard rack ovens because the heated air is distributed and is moved side to side across the chamber 14. Consequently, the foodstuff is then more consistently evenly heated, baked or cooked. This more direct and even distribution also permits a more direct and even heating of the bottom of a foodstuff pan, including the pan at the bottom rack; this is important for many types of baked foodstuff. Also, the distributed circulation paths 34 permit each fan 32a, 32b, 32c, 32d to be operated at a low velocity since there are several short, main convection paths rather than a single long, main convection path that needs to extend throughout the entire chamber 14, around all the foodstuff and racks, and through air louvers. For a similar reason, the heat source 24 may be operated at a lower temperature since lower temperatures may be more easily maintained through the shorter convection paths. The lower fan velocities and lower temperatures both contribute to more efficient and more even heating, baking or cooking (and prevent drying out foodstuff). They also contribute to extending the life of the cooking apparatus 10 which is subjected to less stressful operating parameters. Further, the air flow fans 32a, 32b, 32c, 32d may distribute the heated air in a substantially even manner without the use of air louvers and may particularly distribute the heated air to produce bottom heating of the chamber 14 without the use of air louvers.

Other modifications are possible within the scope of the invention. For example, the cooking apparatus 10 may be configured to have no moving operational parts other than the air flow fans 32a, 32b, 32c, 32d. Also, the enclosure 12 may contain the various systems 20, 30 and other components of the apparatus 10 differently in multiple compartments or in a single compartment. Further, the cooking chamber 14 may be partitioned into more than one sub-chamber, each sub-chamber having independently-operating components. Further, the cooking chamber 14 may be constructed with other refractory-type materials, such as compressed mineral wool or ceramic fiber-type insulation. Further, the air flow fans 32a, 32b, 32c, 32d may operate in reverse so as to pull air from the cooking chamber 14 for heating and then to be circulated (for example, using the air ports 36) and, otherwise, forming the respective distributed air flow circulation paths 34.

Also, the various components of the cooking apparatus 10 may be conventional and known components for a convection oven. They may be configured and interconnected in various ways as necessary or as desired. Further, the cooking apparatus 10 may use other components in combination with or in place of the components described, including those that may be made available via telecommunication means. Such other components may include a steam dispensing system that generates and releases steam into the cooking chamber 14 during operation; a hood exhaust system that releases combustion gas or excess heat; an air wash that provides cooling air around the cooking chamber 14 for further thermal isolation, a flue to relieve pressure within the cooking chamber 14, illumination means for the cooking chamber 14, heated air recirculation system, etc. Also, the cooking apparatus 10 may have computer capabilities to run general purpose and application-specific software that implement algorithms to facilitate the operation of the apparatus 10 and to store information.

What is claimed is:

1. A cooking apparatus, comprising:
a. an enclosure having interior compartments that are adapted to contain components of the apparatus and at least one of which is adapted to contain foodstuff to be heated or cooked;
b. a heating system located in at least one of the compartments which heats the air used in the cooking compartment to heat or cook foodstuff contained therein; and
c. an air flow circulation system located in at least one of the compartments which circulates the heated air throughout the cooking compartment and around and about the foodstuff, the circulation system providing distributed air flow circulation paths that force heated air from one side of the cooking compartment to the other side and back.

2. The apparatus of claim 1, wherein the heating system comprises a heating source that generates the heat used to heat the air in the cooking compartment and a heat exchanger that transfers the generated heat from the heat source to the air circulated by the air flow circulation system.

3. The apparatus of claim 1, wherein the air flow circulation system comprises a plurality of fans arranged in a column along the back or a side wall of the cooking compartment, each of which circulates the heated air within respective top, middle, and bottom volumes of the cooking compartment roughly corresponding to a fan's position in the column arrangement.

4. The apparatus of claim 3, wherein each fan circulates the heated air within a respective volume of the cooking compartment that has a main plane generally defined from the vertical location of the fan in the column to the corresponding vertical positions on the other walls, each volume extending vertically above and below the main plane.

5. The apparatus of claim 3, wherein the plurality of fans are located in the air flow circulation compartment and extend into the cooking compartment at the back or a side wall of the cooking compartment.

6. The apparatus of claim 3, wherein the air flow circulation system further comprises a plurality of air ports formed in a back or a side wall of the cooking compartment that function as air returns for the circulated heated air in the cooking compartment.

7. The apparatus of claim 6, wherein the plurality of air ports is divided in portions that are equal in number to the number of fans and that establish a one-to-one correspondence with the fans.

8. The apparatus of claim 6, wherein the plurality of fans are located in the air flow circulation compartment, each of which is aligned with a respective air port that permits the fan to circulate air within the cooking compartment and that acts as an air return for the circulated heated air.

9. An oven, comprising:
a. a cooking chamber that is adapted to accommodate a food rack holding foodstuff to be cooked or heated;
b. a plurality of fans arranged along the back or a side wall of the cooking chamber; and
c. a plurality of air returns formed in the back or a side wall of the cooking chamber, the fans and the air returns working in combination to form distributed air flow circulation paths that force heated air from one side of the cooking chamber to the other side and back circulating heated air throughout the cooking chamber and around and about the foodstuff held by the food rack.

10. The oven of claim 9, wherein the plurality of air returns are divided in portions that are equal in number to the number of fans and that establish a one-to-one correspondence with the fans.

11. The oven of claim 9, wherein the distributed air flow circulation paths are formed within top, middle, and bottom volumes of the cooking chamber roughly corresponding to a fan's vertical position along the back or a side wall.

12. The oven of claim 9, wherein each distributed air flow circulation path is formed within a respective volume of the cooking chamber that has a main plane generally defined from the vertical location of the fan to the corresponding vertical positions on the other walls, each volume extending vertically above and below the main plane and overlapping adjacent volumes.

13. The oven of claim 9, wherein the distributed air flow circulation paths circulate heated air side to side across the cooking chamber and across a food rack contained therein to equalize the air temperature across the food rack and the foodstuff held by the food rack.

14. The oven of claim 9, wherein the distributed air flow circulation paths circulate heated air side to side across the cooking chamber and across the top and bottom of each foodstuff pan held by a food rack contained therein to maintain a respective even air temperature across the top and the bottom of each foodstuff pan.

15. A method of cooking, comprising:
a. providing a cooking chamber that is adapted to accommodate a food rack having at least one tray holding foodstuff to be cooked or heated;
b. generating heated air in the cooking chamber to cook or heat the foodstuff; and
c. circulating the heated air throughout the cooking chamber using a plurality of primary air flow circulation paths that force heated air from one side of the cooking chamber to the other side and back and across the top and bottom of each foodstuff tray of a food rack contained therein to maintain a respective even air temperature across the top and the bottom of each foodstuff pan.

16. The method of claim 15, wherein the circulating step comprises initially circulating the heated air in a respective primary air flow circulation path at an operating rate of 275 feet per minute.

17. The method of claim 15, further comprising returning circulated heated air from each primary air flow circulation path to be re-heated using the generating step and re-circulated using the circulating step.

18. The method of claim 17, wherein the returning step comprises returning circulated heated air from each primary air flow circulation path primarily using a respectively defined air return path for each primary air flow circulation path.
